(19) United States
(12) Patent Application Publication
(10) Pub. No.: US 2024/0311940 A1
(43) Pub. Date: Sep. 19, 2024

(54) SMART RESIDENT BUILDING SYSTEM AND METHOD

(71) Applicant: Christopher Demetrius Davis, Winter Haven, FL (US)

(72) Inventor: Christopher Demetrius Davis, Winter Haven, FL (US)

(21) Appl. No.: 18/527,238

(22) Filed: Dec. 1, 2023

Related U.S. Application Data
(60) Provisional application No. 63/429,182, filed on Dec. 1, 2022.

(51) Int. Cl. G06Q 50/163

(52) U.S. Cl. CPC G06Q 50/163

(57) ABSTRACT

Smart resident building systems and methods are described.

### TECHNICAL FIELD

Embodiments relate generally to commerce systems, and more particularly, to smart resident building systems and methods including a trade fixture.

### BACKGROUND

In some areas, there may be a lack of grocery stores (e.g., a food desert) or other retail stores. Further, there may be an available space in a residential building or other structure. A need may exist to utilize a vacant residential or other unit as a virtual tenant that is adapted to sell products in the local area. For example, to provide fresh food, organic food and other healthy options to people in a local area where such products may not typically be available.

The problem of food deserts is so significant that it has attracted the attention of Congress. For example, in the 177^{th} Congress, a bill (HR 9281) cited as the Food Deserts Act was drafted specifically to address the issue of food deserts. HR 9281 is incorporated herein by reference in its entirety.

Some implementations were conceived in light of the above-mentioned needs, problems and/or limitations, among other things.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

Food deserts are often located near low-income housing such as public housing. Public housing authorities (PHAs) can include federal authorities (e.g., HUD), state field offices, regional field offices, county public housing authorities and city public housing authorities. The smart resident building system can help PHAs implement programs such as food assistance, SNAP, EBT, WIC, and programs for senior citizens.

The smart resident building system can include physical features such as one or more of:
Door Trade Fixture
Window Trade Fixture
Stairwell Trade Fixture
Elevator Shaft Trade Fixture
Shelving Fixtures
Automated retrieval system
Automated delivery system
Cooling system
Dry Storage System
Liquid storage/dispensing system
Computer Network System

The smart resident system can include functions such as one or more of the following:
Point of sale functions (e.g., accepting payments such as cash, card, touch, etc.)
Robotic arm functions for goods retrieval and delivery
Surveillance/Security
Lidar to gather view
Scale/Weighing functions
Dry Goods Dispensing
Document Processing
Liquid dispensing
LAN/Computer network function (e.g., wired or wireless)

The smart resident building system includes one or more of the above features and functions and is a:
A) building system that can be permanently or temporarily installed in newly constructed buildings, attached to existing buildings, and adapted to portable buildings;
B) building system that can exist as an independent building system and/or exist as an interdependent system with existing systems (e.g., plumbing, electrical, HVAC systems, etc.);
C) building system that can be installed, attached, and adapted to one or more vacant rooms in a vacant unit;
D) building system that can be installed, attached, and adapted to one or more vacant units in a building;
E) building system that can be installed, attached, and adapted to one or more vacant units across one or more buildings;
F) building system installed, attached, and adapted to service the residents of a single building;
G) building system installed, attached, and adapted to serve the residents or two or more buildings;
H) building system installed, attached, and adapted to service the residents of two or more buildings in separate geographic areas;
I) building system installed, attached and adapted to distribute perishable commodities and food staples to the residents of a single building, to the residents of two or more building in the same geographic area, or residents in two or more buildings in separate geographic areas;
J) building system installed, attached, and adapted to facilitate property management operations and activities;
K) building system installed, attached, and adapted to facilitate and automate resident management operations and activities; and
L) building system installed, attached, and adapted to facilitate resident fulfillment transactions, requests, and orders (e.g., medicine delivery, and product delivery and returns from ecommerce companies, etc.).

### Use Cases

Capital/Finance Industry—each smart resident building system can act as a node that provides goods/services in a specific geographic area for the purpose of establishing a capital reserve account. In any industry or trade, the smart resident building system may be used to raise capital through provision of goods/services.

Food Distribution Industry—the smart resident building system may be used as a grocery outlet for a food distributor, wholesaler, retailer, and/or vendor.

Ecommerce industry—the smart resident building system may be used as a resident-centric fulfillment center.

Real estate and property management industry—the smart resident building system may be used to provide value added services as well as a plurality of material upgrades to real estate or property assets, rental services directly from trade fixture rent collection, and contractor/maintenance service requests/management.

Finance Industry/Financial Services—the smart resident building system can be used to acquire new consumer accounts and expand existing business by providing financial services to the community served by the smart resident building system.

Government—the smart resident building system can serve as an information/idea exchange center providing services such as surveys, polls, census, voter registration, and voting (polling place) functions.

### BRIEF DESCRIPTION OF THE DRAWINGS

FIG. 1 shows a network environment for a trade fixture system in accordance with some implementations.

FIG. 2 is a diagram showing an example trade fixture system and its main components in accordance with some implementations.

FIG. 3 is a diagram showing functional units of an example trade fixture system in accordance with some implementations.

FIGS. 4-8 are front views of a sequence an example trade fixture in successive stages of completion in accordance with some implementations.

FIG. 9 is a front view of a completed trade fixture in accordance with some implementations.

FIGS. 10-12 are side views of an example trade fixtures in successive stages of completion in accordance with some implementations.

FIG. 13 shows various top views of an example trade fixture in accordance with some implementations.

FIG. 14 is a diagram of an example computing device configured for electronic employment document control in accordance with at least one implementation.

FIGS. 15-16 are diagrams of example virtual tenant units each having a trade fixture system installed in accordance with some implementations.

### DETAILED DESCRIPTION

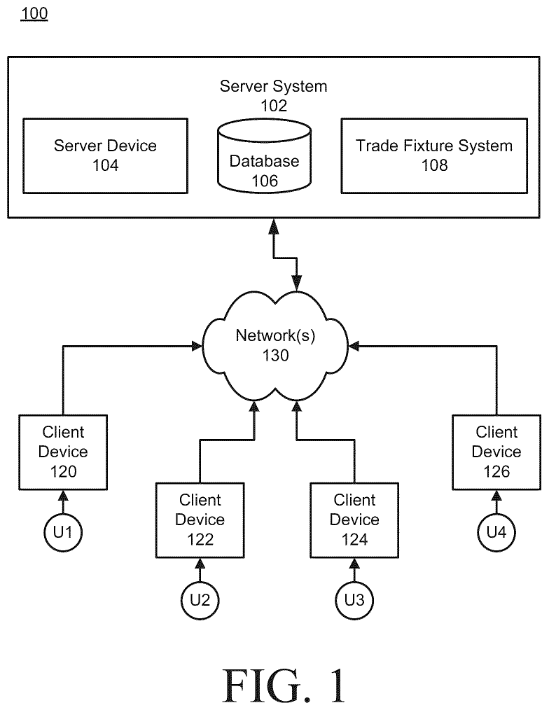

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104 and a database 106 or other data store or data storage device. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

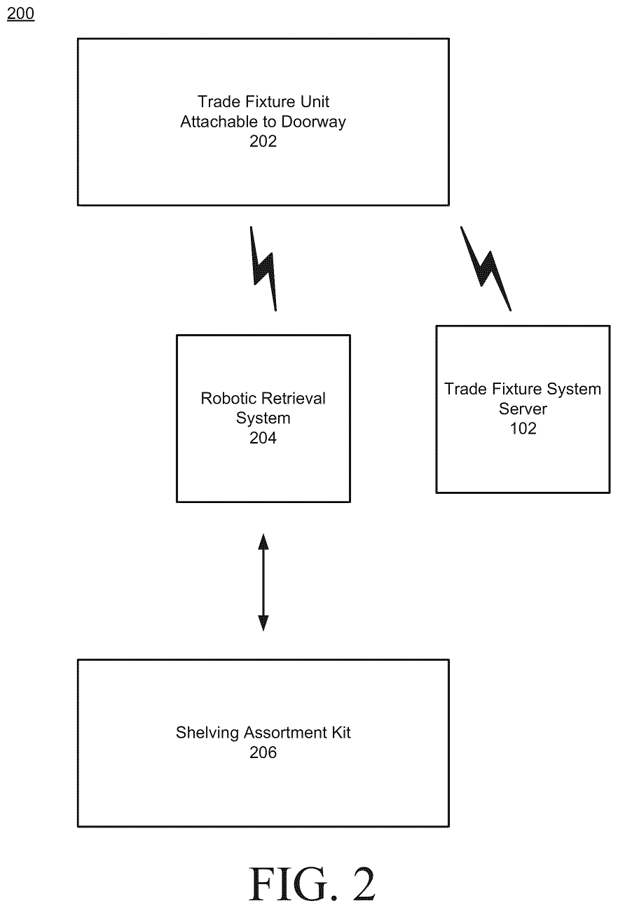

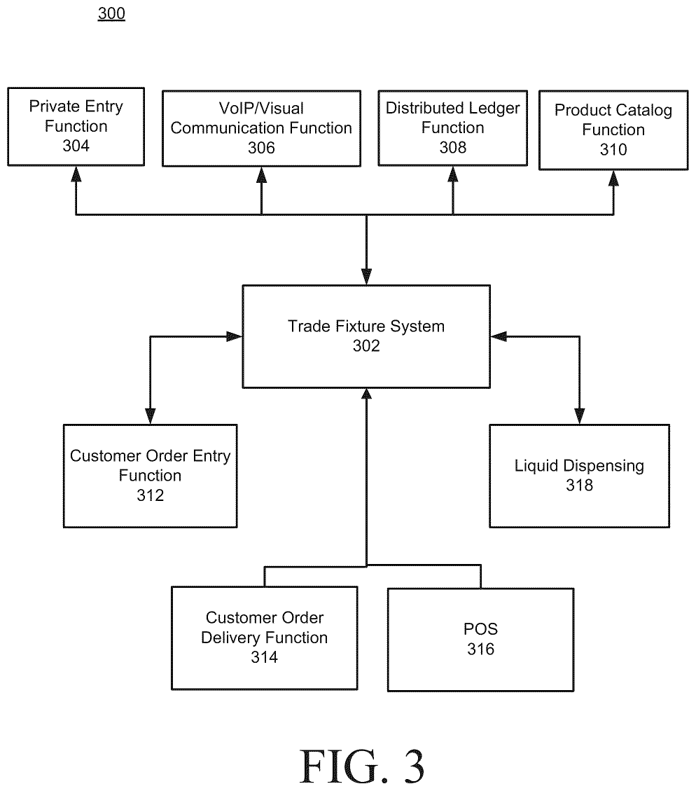

In some implementations, server system 102 and/or one or more client devices 120-126 can provide trade fixture functions described herein (e.g., as shown in FIGS. 2 and 3 and described below).

Various implementations of features described herein can use any type of system and/or service. Any type of electronic device can make use of features described herein. Some implementations can provide one or more features described herein on client or server devices disconnected from or intermittently connected to computer networks.

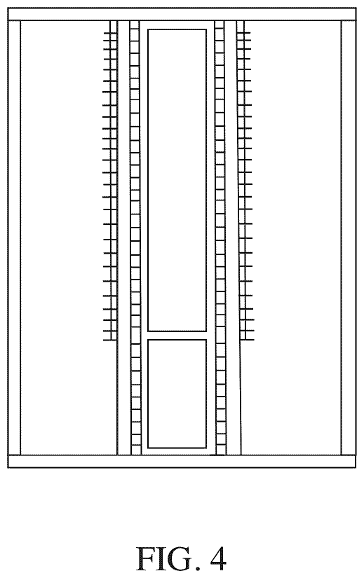

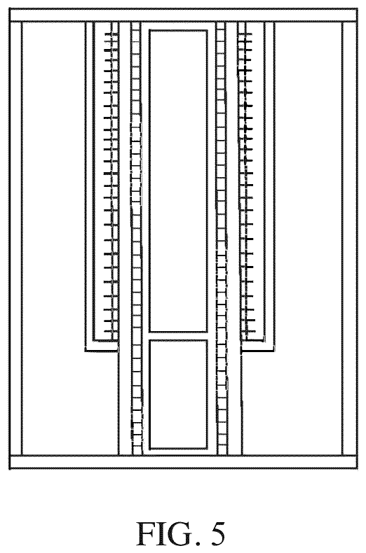

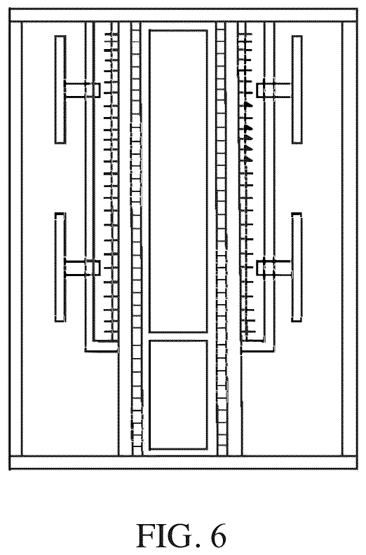

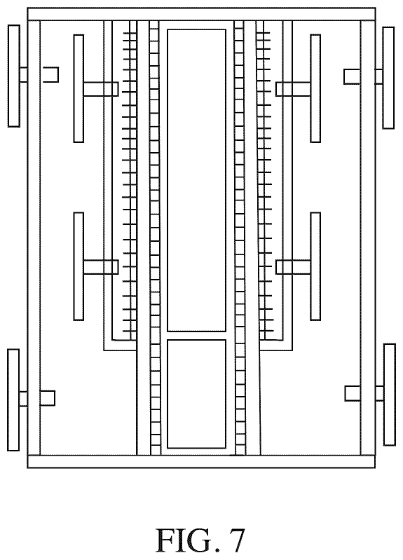

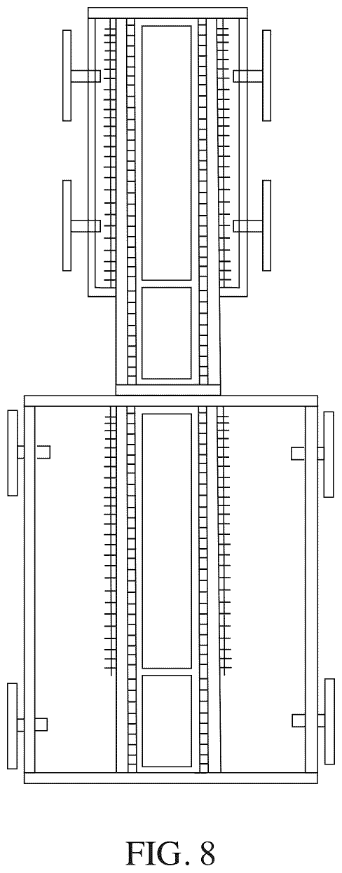

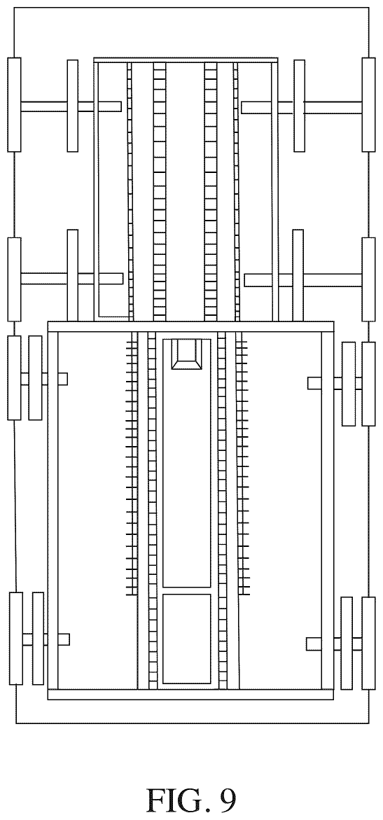

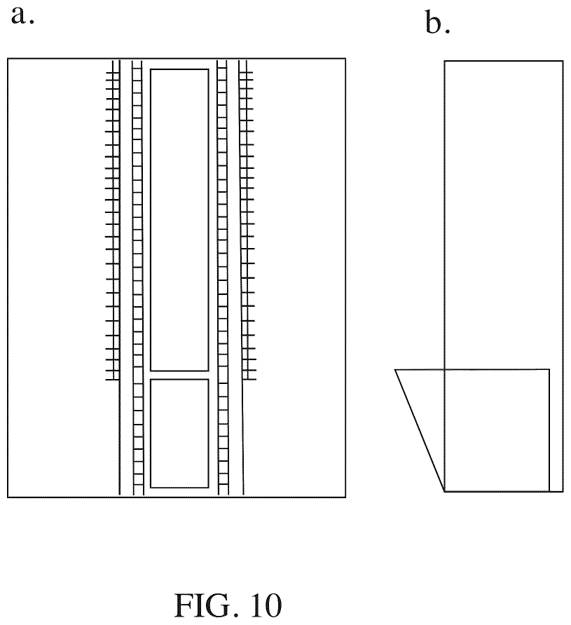

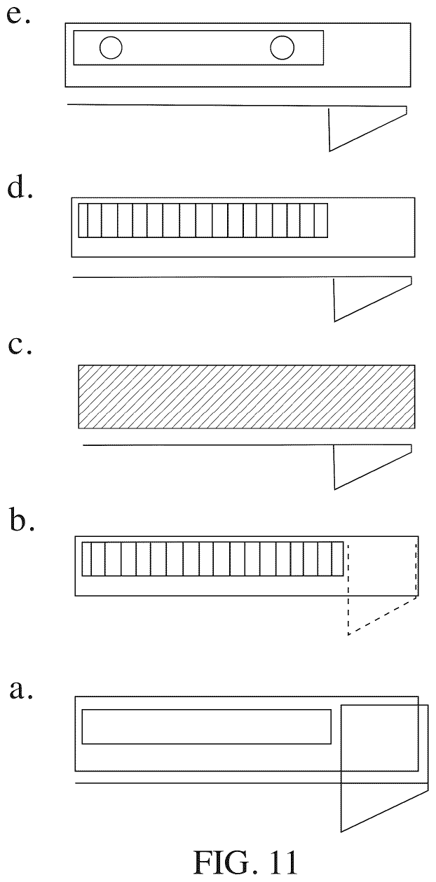

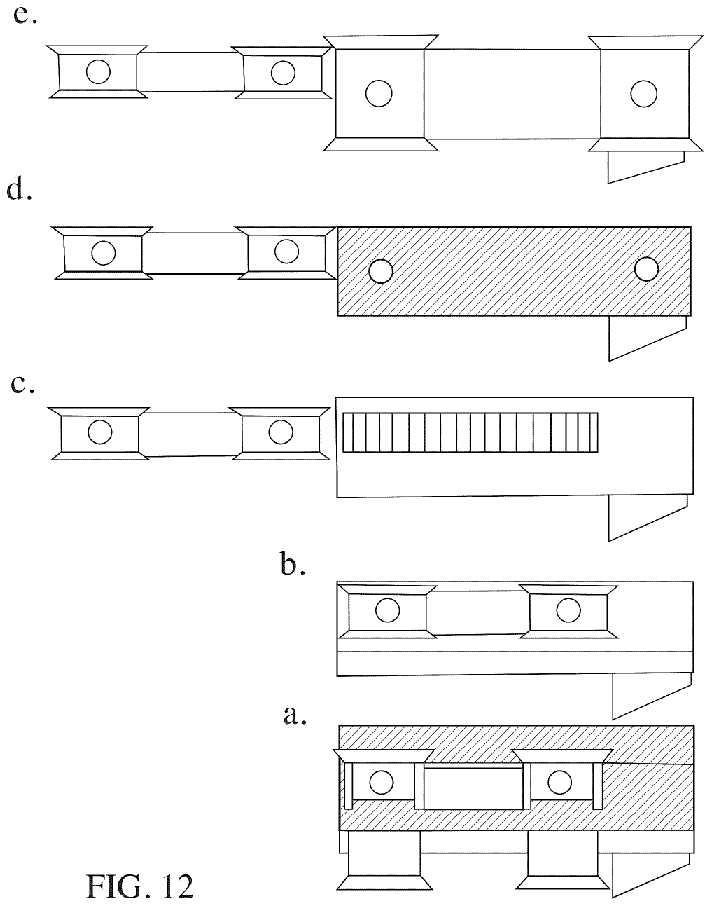

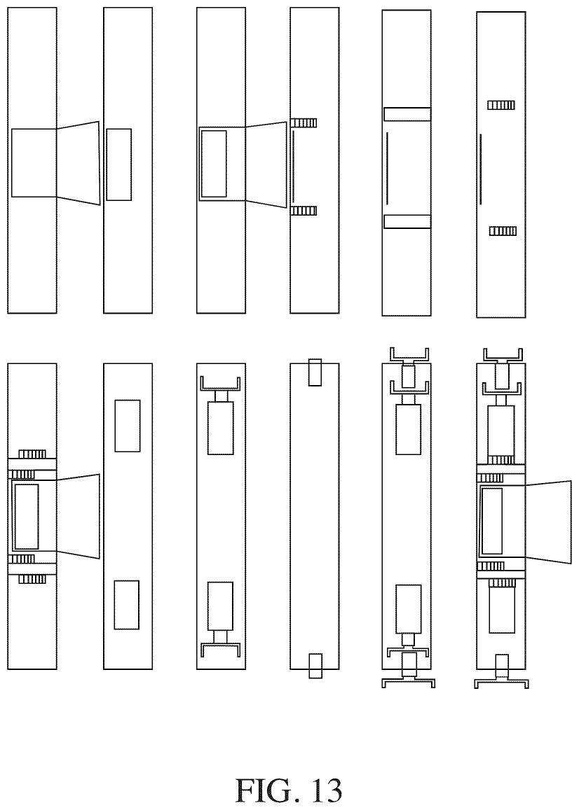

FIG. 2 is a diagram showing an example trade fixture system 200 and its main components in accordance with some implementations. In particular, the trade fixture system includes a trade fixture unit 202 attached to a doorway of a residential dwelling, office, or commercial real estate unit to transform the unit into a virtual tenant for conducting commerce via the trade fixture system. The trade fixture unit is shown in detail in FIGS. 4-13. The trade fixture includes an outside frame, an inside frame, an inside track and an outside track. The trade fixture unit also includes a product delivery bin or box. In units with a liquid dispensing capability, the trade fixture unit can also include a liquid dispensing area.

The trade fixture system 200 also includes a robotic retrieval system 204, which can be any suitable robotic retrieval system such as those used for warehouses, etc. The robotic retrieval system can include functions such as an order receiving function to permit the robotic retrieval system to receive orders from the trade fixture unit. The robotic retrieval system can also include an order itemization function to itemize each item in a customer's order. The robotic retrieval system can also include an order picking function to locate individual items throughout the trade fixture system. The robotic retrieval system can also include an order delivery function to permit the retrieval system to deliver orders to the trade fixture unit.

The robotic retrieval system can also include a geo-spatial awareness function to permit the robot to locate its position within a virtual tenant and to also have object-sensitivity awareness regarding objects in its area of operation. In general, a commercially available mobile robotic piece picking system that can accomplish the functions described herein on its own or in conjunction with another system can be used.

The trade fixture system 200 further includes a shelving assortment kit 206 comprising one or more types of shelving for holding products to be sold and fulfilled by the trade fixture system. The products can include consumer goods, dry grocery goods, refrigerated or frozen foods, perishable goods such as produce, liquids, etc. The trade fixture system 200 also includes a trade fixture server system 102 in communication with the trade fixture unit 202 for restocking, customer service, monitoring, etc. The shelving assortment kit 206 can include one or more commercially available shelving units.

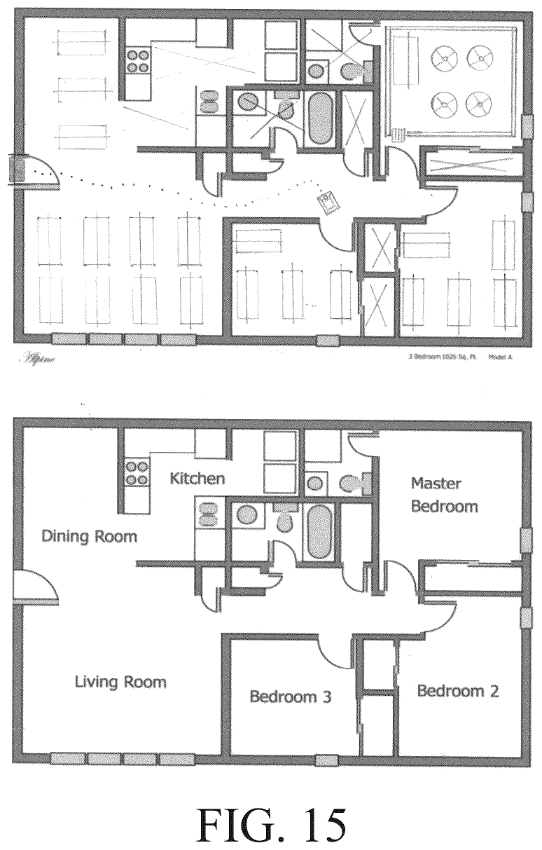

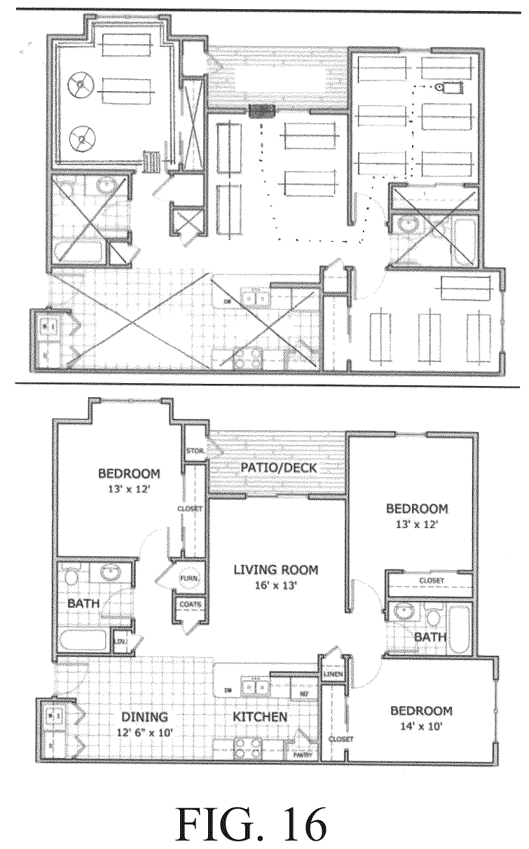

FIGS. 15-16 are diagrams of example virtual tenant units each having a trade fixture system installed in accordance with some implementations.

FIG. 3 is a diagram showing functional units of an example trade fixture system 302 in accordance with some implementations. The trade fixture system 302 can include a private entry function 304, a VoIP/visual communication system 306, a distributed ledger function 308, a product catalog function 310, a customer order entry function 312, a customer order delivery function 314, a point-of-sale function (POS) 316, and a liquid dispensing function 318.

In operation, a trade fixture unit (e.g., 202) is attached to an exterior doorway of a residential or commercial unit. A plurality of anchors (e.g., 8 anchors in some implementations as shown in FIGS. 4-13) are used to secure the trade fixture to the doorway.

A customer approaches the trade fixture unit and activates the private entry function 304 (e.g., a keypad, biometric or other secure identification system). The private entry function 304 assures that each trade fixture unit operates in accordance with local regulations, controls admission to the system, and verifies a tenant in a Defined Tenant Community (DTC).

Once the user has been verified by the private entry function, an operator is notified. The VoIP/visual communications function 306 is a method for users (or customers) of the trade fixture system to communicate with operators or support personnel of the trade fixture system that may be on-premises or off-premises.

The customer then places an order via the customer order entry function 312. The operator can use the robot to pick the order and deliver it to the trade fixture delivery box or bin via the customer order delivery function 314. The customer pays of the order (e.g., via the POS function 316). The order picking and delivery can also be fully or partially automated.

The distributed ledger function 308 records three accounts each corresponding to one of the product catalogue function 310, the order entry function 312, and the order delivery function 314. The product catalogue function 310 tracks the wholesale value of products delivered to trade fixture. The customer order entry accounts track the value of customer transactions, and the customer order delivery function tracks the goods delivered and or returned.

Once the customer completes the order payment process via the POS function 316, the operator can release the hatch for the delivery box or bin so the customer can retrieve their goods. The release function can also be fully or partially automated. The customer retrieves the order and leaves the trade fixture.

The product catalogue function 310 permits the providers of goods to the trade fixture system to input product offerings into the system.

The liquid dispensing function 318 is a function that can dispense liquids (e.g., beverages, cleaning products, water, etc.) in fluid measurements or other measurements.

In some implementations, special orders can be received by a trade fixture for delivery to the customer at a future date. Also, in some implementations, the trade fixture can alert customers to specials or sales on items (e.g., perishable items that may be expiring soon). A trade fixture can also be configured for other door sizes or types such as a garage door (e.g., rolling overhead door), etc.

In some implementations, the trade fixture system can communicate with customers (e.g., via the trade fixture server 102) and/or vendors or suppliers. In some implementations, when a new virtual tenant (e.g., a residential or commercial unit is equipped with a trade fixture system) comes online for a given location, retailers and wholesalers can be alerted to the presence of the new trade fixture system cans see the location, specifications (e.g., square footage), and then be permitted to bid on supplying products to the new virtual tenant trade fixture system.

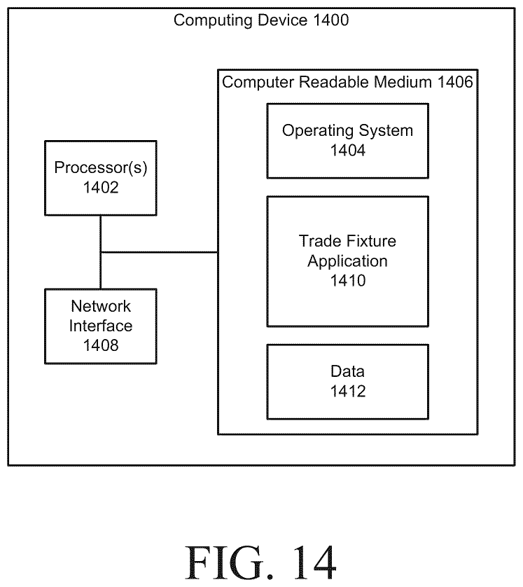

FIG. 14 is a diagram of an example computing device 1400 in accordance with at least one implementation. The computing device 1400 includes one or more processors 1402, nontransitory computer readable medium 1406 and network interface 1408. The computer readable medium 1406 can include an operating system 1404, a trade fixture application 1410 (client and/or server) configured to perform one or more functions described herein and a data section 1412 (e.g., for storing inventory data, transaction data, customer data, etc.).

In operation, the processor 1402 may execute the application 1410 stored in the computer readable medium 1406. The application 1410 can include software instructions that, when executed by the processor, cause the processor to perform operations to control a trade fixture system in accordance with the present disclosure (e.g., performing associated functions described above and shown in FIG. 3).

The application program 1410 can operate in conjunction with the data section 1412 and the operating system 1404.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules) may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media to control a trade fixture system.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A smart resident building system comprising:
a trade fixture.
